(19) United States
(12) Patent Application Publication
(10) Pub. No.: US 2004/0070639 A1
(43) Pub. Date: Apr. 15, 2004

(54) Monitoring print performance

(76) Inventors: Wendy L. Zerza, Boise, ID (US); Vincent C. Skurdal, Boise, ID (US); Boyd Wilkes, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/268,382

(22) Filed: Oct. 10, 2002

(51) Int. Cl. B41J 29/393

(52) U.S. Cl. 347/19

(57) ABSTRACT

A method and apparatus for printing with a printer includes detecting an errant page condition, and interrupting a print job in response to the possible errant page condition. An errant page condition can be the monitoring the printer for any waste of a consumable that will increase the cost per page to print. The cost per errant page can be approximated, and when the approximated cost per errant page is above a selected threshold level, the print job is interrupted. A list of options is then presented to a user interface to allow the user to select a course of action. A printing apparatus implements this method. The controller is programmed to interrupt the print job and present the options to the user interface.

### TECHNICAL FIELD

Embodiments of the invention relate generally to printing images. More particularly, the embodiments relate to a print continue option for printers.

### BACKGROUND INFORMATION

There are many types of printing mechanisms. Different types of printing mechanisms are useful for different types of printing jobs. For example, inkjet printing is capable of producing high-quality color photographs from digital images. One type of inkjet printing mechanisms use cartridges, often called “pens,” which eject drops of liquid colorant, referred to generally herein as “ink,” onto a page. Each pen has a printhead formed with very small nozzles through which the ink drops are fired. To print an image, the printhead is propelled back and forth across the page, ejecting drops of ink in a desired pattern as it moves. The particular ink ejection mechanism within the printhead can include a piezo-electric or a thermal printhead mechanism. Other types of inkjet printers use individual pens rather than cartridges. Generally, four colors (black, cyan, magenta and yellow) need to be mixed to form an image. Problems can occur when one or more of the four colors becomes unavailable. One of the four colors can become unavailable for any number of reasons including simply running out of one color. Inkjets can use liquid toner or dry toner.

One of these problems associated with one of the colors becoming unavailable includes wasting consumable resources. There are many consumable resources or consumables associated with printing a job. Ink, liquid toner or dry toner are one class of consumables or consumable resources. Inks, liquid toners or dry toners vary in cost. Another class of consumable resource or consumable is the media or paper on which a job is printed. The cost of printing media can be very little or may be in excess of $1.00 per sheet of media. Ordinary printing paper, for example, is inexpensive. Sometimes special media is used for printing high-quality photographs. The cost of photo-grade media can be very high. Sometimes waste can occur due to the fact that printing may be allowed to continue when doing so will waste a consumable. For example, if a user wants ten prints of a single photograph, the user will load ten pages of high cost media into the printer. The problem occurs when the ink or toner for one or more colors is depleted somewhere between the start and finish of the ten pages. If allowed to continue, then one or more pages of the high-cost, photo-grade media will be wasted since all the colors of ink or toner needed to make a high quality photo were not available. In this case, the cost of the ink or toner far outweighs the cost of the paper. In other instances, another consumable will be wasted. For example, when expensive inks are being used, the other inks will be wasted when printing without one or more of the colors. Simply put, a quality printing job will not result if one or more of the colors necessary to produce a quality output is not available.

### BRIEF DESCRIPTION OF THE DRAWINGS

FIG. 1 is a perspective view of a printing apparatus according to one embodiment of the invention.

FIG. 2 is a schematic view of a printing apparatus that includes the printer controller and a host computer according to an embodiment of the invention.

FIG. 3 is a flow diagram illustrating a method according to an embodiment of the invention.

FIG. 4 is a flow diagram illustrating a method according to another embodiment of the invention.

FIG. 5 is a screen shot of a print screen of one embodiment of this invention.

FIG. 6 is a schematic diagram illustrating a computer readable medium and associated instruction set according to an embodiment of the invention.

### DETAILED DESCRIPTION OF THE INVENTION

In the following detailed description of the embodiments, reference is made to the accompanying drawings that form a part hereof, and in which are shown by way of illustrating specific embodiments in which the invention may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of present inventions. The following detailed description, therefore, is not to be taken in a limiting sense, and the scope of various embodiments of the invention is defined only by the appended claims, along with the full range of equivalents to which such claims are entitled.

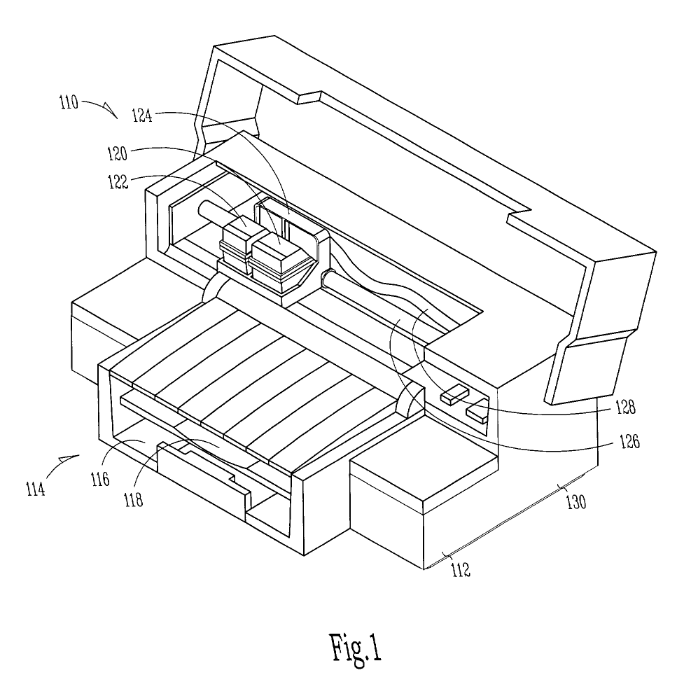

FIG. 1 shows one embodiment of a printing device invention. FIG. 1 includes an inkjet printer 110, which may be used in an office or home environment for business reports, correspondence, desktop publishing, pictures and the like. The inkjet printer 110 includes a chassis 112 and a print medium handling system 114 for supplying a print medium, such as a sheet of paper or high-quality photo paper (not shown), to the printer 110. In addition to paper, the print medium may be any type of suitable sheet material, such as card-stock, transparencies, mylar, foils, and similar print medium. The print medium handling system 114 includes a feed tray 116, an output tray 118, and a series of rollers (not shown) for delivering the sheets of paper from the feed tray 116 into position for receiving ink from a plurality of inkjet cartridges 120, 122. As illustrated, inkjet cartridge 120 is a tri-color pen color ink cartridge. Inkjet cartridge 122 is a black monochrome ink cartridge.

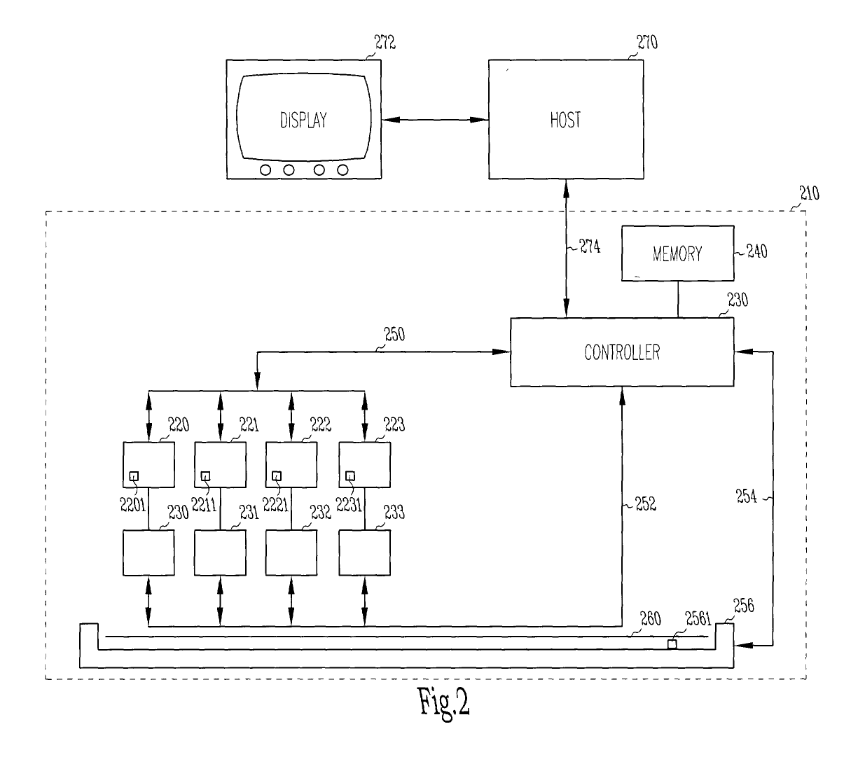

The ink cartridges or pens 120, 122 are transported by a carriage 124 which may be driven along a guide rod 126 by a drive belt/pulley and motor arrangement (not shown). The pens 120, 122 selectively deposit one or more ink droplets on a sheet of paper or other medium in accordance with instructions received via a conductor strip 128 from a printer controller 130 located within chassis 112, for instance at the location shown in FIG. 1. The controller 130 generally receives instructions from a computer (shown in FIG. 2), such as a personal computer. A monitor (shown in FIG. 2) coupled to the computer can be used to display visual information to an operator, such as the printer status or a particular program being run on the computer. Screens on the monitor are one form of user interface to the printer 110. It should be noted, that the inkjet printer 110 shown is an example of one type of printer that employs an embodiment of this invention. The various embodiments of the invention described herein are not limited to this one example model of a printer and can be used in any type of printer that uses any type of printing mechanism.

FIG. 2 is a schematic view of a printing apparatus that includes a printer controller and a host computer according to an embodiment of this invention. The controller 230 controls many aspects of the printer. The controller 230 controls the transfer of information between ink reservoirs 220, 221, 222 and 223, as well as the control of information to and from the printheads 230, 231, 232 and 233. Much of the information is obtained from memory or a storage device 240. The memory 240 includes an indication of the type of ink and the ink colors in the various reservoirs 220, 221, 222, and 223. The memory 240 also contains information as to the levels of ink within the various reservoirs 220, 221, 222, 223. A fluid level sensor 2201, 2211, 2221, and 2231 is located to monitor the level of each of the various reservoirs 220, 221, 222, 223, respectively. The fluid level determined by the fluid level sensor 2201, 2211, 2221, and 2231 is placed into memory 240. Electrical contacts associated with each of the reservoirs 220, 221, 222, 223 receive signals over conductive paths represented by the line 250.

The controller 230 also selectively activates each printhead 230, 231, 232, 233 to eject or deposit ink from the respective reservoirs 220, 221, 222, and 223 onto a print media 260. The printheads 230, 231, 232, 233 are controlled by line 252 that sends signals to the printheads from the controller 230. The printheads 220, 221, 222, and 223 are also capable of providing signals to the controller. In some embodiments, the signals provided to the controller 230 are feedback signals which is part of a feedback control loop. A line 254 is attached to a printer mechanism 256 for controlling media transport and movement of a carriage, such as a tray or carriage 124, 224. In one embodiment, attached or associated with the printer mechanism 256 is a media type sensor 2561. The media type sensor senses the type of media 260 associated with a particular print job. The media type sensor can be any type of sensor, including a sensor for reading indicia. The indicia that can be read with different types of sensors 2561 include bar codes, labels, switch bumps, magnetically readable media, radio frequency label or read-only chips. It should be understood that other types of sensors can be used in place of the indicia reading sensors.

The controller 230 is also communicatively coupled to a host computer 270. The host computer 270 is shown connected to a display device 272. The host computer 270 can be a variety of information sources such as a personal computer, work station, or server, to name a few, that provide image information to the controller 230 by way of a data link 274. The data link 274 may be any one of a variety of data links such as an electrical link, radio frequency link, or an infrared link. The data link transfers information between the host computer 270 and the printing apparatus 210. The printing apparatus includes the entire schematic arrangement shown in FIG. 2. Generally, the dotted line box, designated by the reference number 210, includes the components associated with the printer.

Various parameters can be stored in the storage device or memory 240, including an actual count of ink drops emitted from a particular printhead 230, 231, 232, 233, data associated with an ink reservoir or container 220, 221, 222, 223, as well as the ink type and color, the container size, the age of the ink, the printer model or identification number, and cartridge usage information. Also stored within the memory is information on the print media 260, which in one embodiment, is obtained from media type sensor 2561. In other embodiments, a print command includes an indication of the paper type and information can be obtained from the print command regarding the type of print media being used. For example, in embodiments of printers where multiple paper trays are available, the type of print media must be designated as relating to a particular tray. In other embodiments, the resolution setting indicates that high-quality photo type print media is being used. The parameters listed above are just examples of the listings of parameters storable within the memory 240.

The controller 230 is included in an information handling system and may be either a microprocessor or a dedicated controller. An information handling system is any device that stores, manipulates or handles information such as data. The controller is capable of detecting the colors within the reservoirs 220, 221, 222, 223, by detecting a color from indicia associated with the reservoirs 220, 221, 222, 223. Indicia can be any type of readable indicator including bar codes, switch bumps, magnetically readable media, radio frequency label or read-only chips. In one embodiment, data associated with ink within a cartridge or reservoir 220, 221, 222, 223 is obtained through electrical contacts associated with the cartridge or reservoir 220, 221, 222, 223. The host computer 270 can include commands in a print command sent from the host 270 over the data link 274.

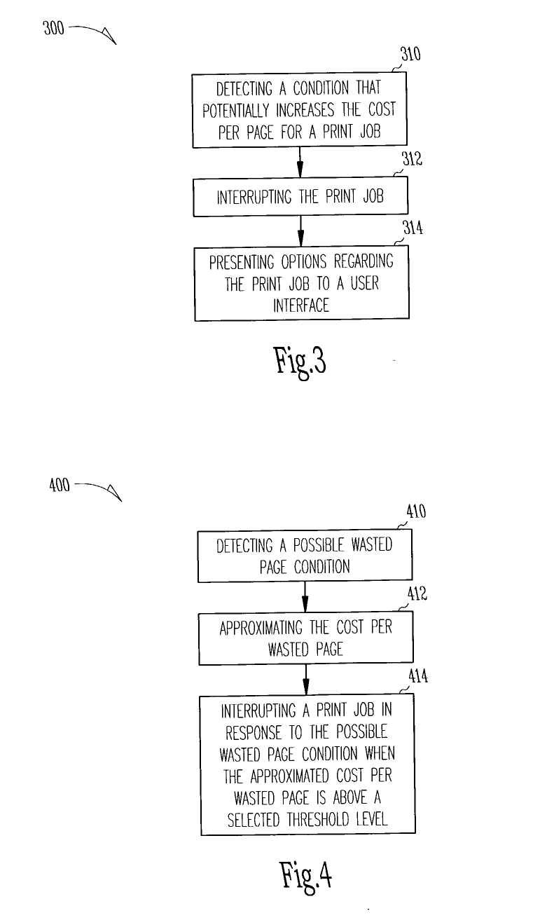

FIG. 3 is a flow diagram 300 illustrating a method according to an embodiment of the invention. The method includes monitoring a printer to detect a condition that potentially increases the cost per page for a print job, as depicted by reference numeral 310. After detecting a condition that potentially increases the cost per page, the print job is interrupted as depicted by reference numeral 312. An initial cost per page considering all the consumables such as ink and paper is initially made. Certain conditions will generally result in a higher cost per page. When one of these conditions is detected, a new cost per page is determined. The interruption of the print job 312 can be based on a threshold level associated with the increased cost per page. In other words, a user could select a threshold level where the interrupt would occur. Below the threshold level, an interrupt in the print job would not occur. One example of a condition that potentially increases the cost per page includes detecting the unavailability of an ink. The unavailability of an ink can be the unavailability of a monochrome color such as black or the unavailability of any of a number of colors, typically cyan, magenta, yellow or black.

Another condition that potentially increases the cost per page would be an indication of low levels of ink in a reservoir associated with the printing apparatus. The reason that either of these conditions could result in an increased cost per page is because the lack of ink may produce a printed output which will not meet the standards of the print job. In other words, without ink, pages of media can be printed, however, the output may not be useful or, more simply put, wasted. In some embodiments, the method 300 also includes presenting options regarding the print job to a user interface. In some embodiments, the user interface is the display 272 associated with the host computer 270 which is attached to the printer via link 274. In other embodiments, the printer 110, 210 includes a user interface on the housing. In some instances, the user interface on the housing or chassis 112 may include a display on the housing or chassis 112 of the printer 110, 210. The display on the chassis 112 of a printer 110 includes a series of switches and LEDs which prompt questions. The LEDs are lit and options selected via switches associated with the LED. In other embodiments, the display on the chassis 112 of the printer 110 is a liquid crystal display.

A plurality of options may be presented at the user interface. One of the options may be to quit the print job. Another of the options may be to replace or substitute one of the consumables. In this instance, a higher cost per page media may be removed and a lower cost per page media may be substituted. For example, a business person may be pressed for a presentation. Although it would be preferable to have a high quality output, the resources available for the printer may not make this possible. For example, on a color inkjet printer, when one of the colors runs out, the quality of the output goes down. The errant page or potentially wasteful condition that would cause a higher cost per page would be that output printed on the media may be “wasted.” If the business person would have time to replace an ink cartridge so that all colors were available, he or she would either quit the job or replace the cartridge and then continue on. If, however, on the other hand, replacing the consumable resource causing the potential increase in cost per page was not an option, the business person may decide to continue with printing the job even though the output quality is lower than originally anticipated since it is much more important to present the information even though the quality of the output may be less than anticipated. Therefore, the options include fixing the condition that potentially increases the cost per page, such as replacing an ink cartridge that includes all the colors, or substituting a less costly consumable resource for a consumable resource originally designated for the print job, or quitting the print job. This might occur when a user is printing a photograph. For example, a photographer may be cropping a picture and want to know that it is done to their satisfaction. In this case, if a condition such as a low ink level or ink unavailable condition is detected, the options presented to the user include substituting a lower-cost media for the high quality photo output type media presently in the paper tray of the printer 110, 210. In this instance, the photographer could double check to make sure that the cropping is just right on the picture output from the printer using a less expensive media. This option allows the photographer to find out if the cropping was correct at a lesser cost.

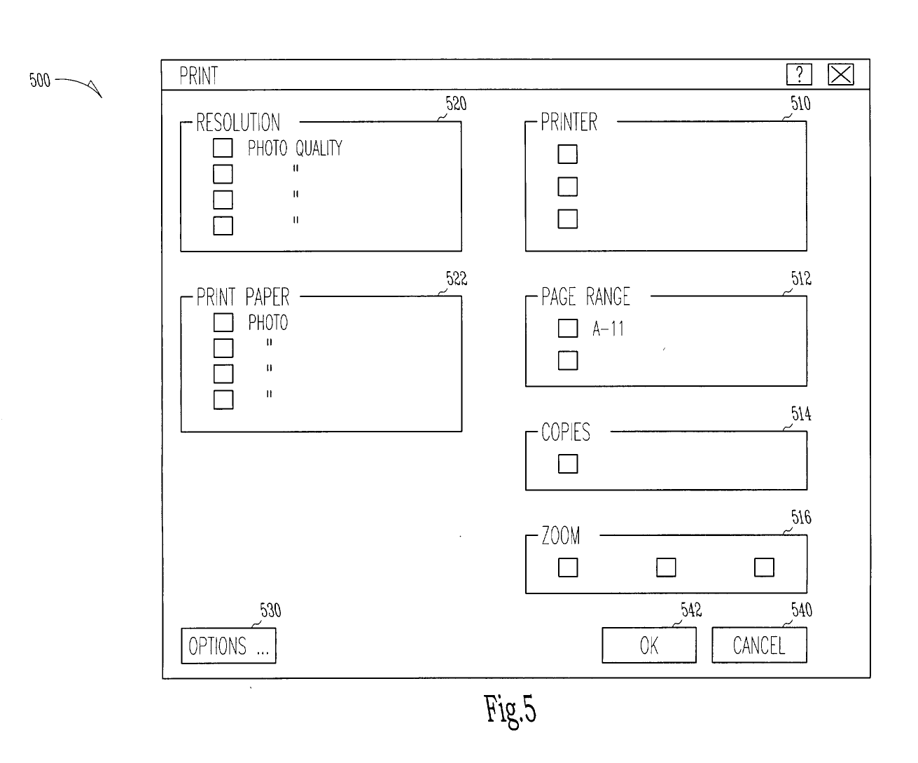

FIG. 4 is a flowchart illustrating another method 400 according to an embodiment of this invention. The method includes monitoring a printer to detect a an errant page condition, as depicted by reference numeral 410. The errant page condition includes a wasted page condition or a page that is output that is less than the desired output sought. The cost per errant page is then approximated as depicted by reference numeral 412 and the print job is interrupted in response to the errant page condition when the approximated cost per errant page is above a selected threshold level 414. One of the errant page conditions is an ink low or ink unavailable condition in the printer 210. Sensors 2201, 2211, 2221 and 2231 monitor or sense the ink levels in reservoirs 220, 221, 222 and 223, respectively. The sensors 2201, 2211, 2221 and 2231 send information about the sense level of ink in each of the respective reservoirs over line 250 to the controller 230 and into memory 240. The controller 230 is able to determine if the levels associated with the sensors 2201, 2211, 2221 and 2231 are either low levels or empty levels. At either low levels or empty levels, a possible wasted page condition or an errant page condition is determined by the controller 230. The controller can then determine the approximate cost per errant or wasted page. If the cost per wasted page or errant page is over a selected threshold level, it can generate an interrupt in the printing process.

The sensors 2201, 2211, 2221 and 2231 are not the only devices used to determine an ink unavailable condition. Each of the printheads 230, 231, 232 and 233 also outputs information onto line 252 which is connected to the controller 230. An ink unavailable condition may also result when a printhead is malfunctioning. In other words, a sensor, such as 2201, 2211, 2221 and 2231, can indicate that the levels of ink in a reservoir are appropriate or not low, yet an associated printhead 230, 231, 232 and 233 may not be depositing or ejecting ink. The output from the printheads 230, 231, 232 and 233 on line 252 can indicate when one or more of the printheads is failing to eject or deposit ink. This is another potentially wasteful condition which would result in calculating or approximating the cost per wasted page and which could generate an interrupt in the print job. The invention also contemplates that other consumables can contribute to an increase in the cost per page, such as use of one or more expensive inks when one of the ink colors has become unavailable. An errant page condition occurs whenever the desired output is less than the actual output. In some instances, the errant page condition can result in a wasted page or a page the user will not use.

Interrupting the print job includes producing a query at a user interface to the printer 110, 210. Again, one type of user interface is the display 272 associated with the host computer 270. In some embodiments, the printer 110, 210 includes a display on the chassis 112. In still other embodiments, the display 272 associated with the host computer 270, as well as a display on the chassis 112 of the computer 110, 210, are both used for presenting options or queries to the user. The options or queries include querying the user to determine whether to continue the print job or cancel the print job. Another possible query presented to the user interface is whether to postpone or delay a print job until either a less expensive consumable can be substituted for a more costly consumable, thereby lowering the cost per wasted page, or until the condition which triggers the increased cost can be remedied. In the example above, this would entail either fixing the printhead or unclogging the printhead 230, 231, 232 and 233, or replacing an ink cartridge 220, 221, 222 and 223. For different types of printing mechanisms, a cartridge may not be replaceable but an ink pen may be refilled or a new ink pen substituted for one that is either at a low level or empty level. Approximate cost per wasted page, in some embodiments, includes detecting the use of a particular consumable. It is further contemplated that in other embodiments, the options will include more than disabling or enabling a feature. The options may be to replace a component, continue printing and use the less than desired output, or some other option.

In some instances, indicia may be read from the consumable to determine the approximate cost per wasted page associated with the consumable. For example, the sensor 2561, associated with the printer mechanism 256, may be used to read some indicia off of a page of media. One example is that high quality, photo-type print media can include a bar code label which could be read directly by the sensor 2561 as the media is being handled by the printer mechanism 256. Of course, there are other types of indicia that may be read including radio-frequency IDs, magnetic strips, or bumps, just to name a few. Another way to approximate the cost per wasted page is to take data from the print command to determine, for example, the approximate cost associated with the media. One example might be designating a paper tray since different papers are typically kept in designated paper trays. For example, high quality photo-type paper might be kept in a selected tray. In other embodiments, a more low-end printer requires that when the high quality photo paper is placed in the tray, the user presses a button to indicate that high resolution print job for the particular paper loaded into the printer. In some other printing mechanisms or printers 110, 210, the print command may require that the user indicate the type of paper or the resolution required for the particular print job. From this data associated with the print command, the controller 130, 230 can determine that high quality, photo-type printing paper may be within or on the print tray. In other embodiments of the invention, the sensor 2561 is a gloss sensor which measures the amount of light reflected off a surface of the media. High-quality photo-type paper, in many instances, will reflect more light than other types of paper because of the glossy surface associated with the paper. Transparencies will have very little reflected light and will minimally impact the gloss sensor.

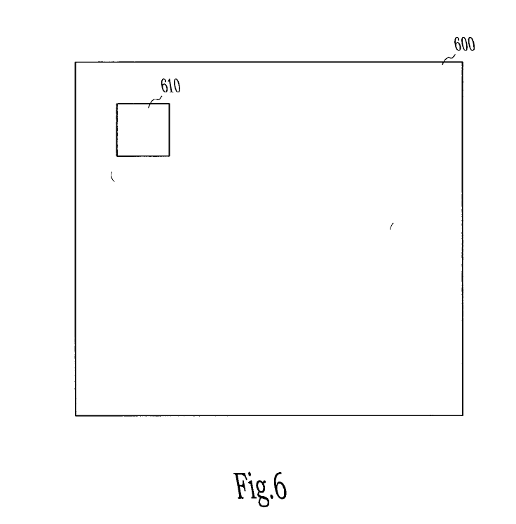

FIG. 5 is a screen shot of a print screen 500 according to one embodiment of the invention. The print screen 500 presents the user with a variety of options for printing a particular print job. The print screen includes options as to the location of a printer, as depicted by reference numeral 510, options as to the page range of the print request, as depicted by reference numeral 512, as well as options for the number of copies and the zoom, as depicted by reference numerals 514 and 516, respectively. The print screen 500 also includes options for selecting various resolutions, as depicted by reference numeral 520 and options as to the print paper or media used, as depicted by reference numeral 522. The print screen also includes an options screen which can be used to designate further options. The options portion of the screen is depicted by reference numeral 530. Once all the various options are selected, the user can either cancel the print request by clicking on a cancel button 540 or can OK the print request by clicking on an OK button 542. Data from the print request 500 can be used to determine the type of paper as well as the resolution of printing and can be processed along with other available information associated with the status of other consumables. It should be noted that in some embodiments, only the resolution option 520 will appear on the print request 500 and in another embodiment of the invention, only the print paper option 522 will be shown on the print request screen 500.

In various embodiments of the invention, data from either one or both of these print requests can be used to determine the type of media being printed to for the particular print job. Furthermore, it should be understood that the resolution option 520 and the print paper option 522 can be found under the options button 530 in other embodiments of this invention. In other words, the options for resolution 520 and print paper 522 may not be found on the initial print screen 500 which initially is shown to the user. The resolution 520 and the print paper option 522 may be stored on a single screen or separate screens after the additional options button 530 is clicked on.

FIG. 6 is a schematic diagram illustrating a computer-readable medium 600, an associated instruction set 610, according to an embodiment of this invention. The computer-readable medium 600 can be any number of computer-readable medium including a floppy drive, a hard disk drive, a network interface, an interface to the internet, or the like. The computer-readable medium can also be a hard-wired link for a network or be an infrared or radio frequency carrier. The instruction set 610 can be any set of instructions which are executable by an information handling system associated with the printing apparatus discussed. For example, the instruction set may include the method 300 and 400 discussed and any other embodiments discussed with respect to FIGS. 3 and 4 above. Other instruction sets may also be placed on the computer-readable medium 600.

The above-described invention has many advantages. Among the advantages is that the printer, before wasting consumables, is interrupted and options or queries are presented to the user via the user interface. Also advantageous is that the user may elect not to be bothered if the cost per wasted page or pages or the incremental increase to the cost per page of the print job is relatively small. In other words, the option exists to set a threshold. The threshold that can be set may be on a cost per page or a total amount of waste basis. There are also other advantages to this invention.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

What is claimed is:

1. A method for printing with a printer comprising:
monitoring the printer for a possible errant page condition;
approximating the cost per errant page; and
interrupting a print job in response to the errant page condition when the approximated cost per errant page is above a selected threshold level.

2. The method for printing of claim 1, wherein interrupting the print job includes producing a query at a user interface to the printer.

3. The method for printing of claim 1, wherein interrupting the print job includes querying a user to determine whether to continue the print job.

4. The method for printing of claim 1, wherein interrupting the print job includes querying a user regarding substitution of a consumable.

5. The method for printing of claim 1, wherein detecting the errant page condition includes detecting an ink unavailable condition.

6. The method for printing of claim 1, wherein detecting the errant page condition includes detecting an ink unavailable condition and wherein detecting an ink unavailable condition includes detecting that at least one of a first color, a second color, a third color, or a fourth color of ink in unavailable.

7. The method for printing of claim 1 wherein approximating the cost per errant page further includes detecting the use of a particular consumable.

8. The method for printing of claim 7 wherein detecting the use of a particular consumable includes reading indicia from the consumable.

9. The method for printing of claim 7 wherein detecting the use of a particular consumable includes gathering data regarding the consumable from a print driver.

10. The method for printing of claim 7 wherein detecting the use of a particular consumable includes gathering data previously entered into a print menu regarding the consumable.

11. A set of instructions executable by a suitably programmed information handling system, comprising:
detecting a possible errant page condition;
approximating the cost per errant page; and
interrupting a print job in response to the possible errant page condition when the approximated cost per errant page is above a selected threshold level.

12. The set of instructions executable by a suitably programmed information handling system further including a computer readable medium, the computer readable medium including the set of instructions.

13. A method for printing comprising:
detecting a condition that potentially increases a cost per page for a print job; and
interrupting the print job.

14. The method of claim 13 wherein detecting a condition that potentially increases the cost per page further comprises:
determining an initial cost per page associated with a print job; and
detecting a condition that potentially increases the cost per page above a selected threshold above the initially determined cost per page.

15. The method of claim 13 wherein detecting a condition that potentially increases the cost per page further comprises detecting an unavailability of an ink.

16. The method of claim 13 further comprising presenting one or more options regarding the print job to a user interface.

17. The method of claim 16 wherein the one or more options include substituting a less costly consumable resource for a consumable resource designated for the print job.

18. The method of claim 16 wherein the one or more options include continuing the print job.

19. The method of claim 16 wherein the one or more options include canceling the print job.

20. A printing apparatus comprising:
a first sensor for identifying an errant condition;
means for determining a type of consumable associated with a print job; and
means for interrupting a print job in response to the identification of the errant condition.

21. The printing apparatus of claim 20 wherein means for interrupting the print job includes a controller sending a command to interrupt the print operation.

22. The printing apparatus of claim 20 wherein means for determining a type of consumable associated with a print job includes a second sensor associated with the consumable.

23. The printing apparatus of claim 20 wherein means for determining a type of consumable associated with a print job includes gathering information from a print command related to the consumable.

24. The printing apparatus of claim 20 further comprising means for approximating an increased cost per page associated with the print job.

25. The printing apparatus of claim 24 wherein the means for interrupting a print job in response to the identification of the errant page condition interrupts the print job when the approximated increase in the cost per page is above a selected threshold.
